(19) United States
(12) Patent Application Publication
(10) Pub. No.: US 2002/0091341 A1
(43) Pub. Date: Jul. 11, 2002

(54) Device to assist in relaxing and relieving the stress of a subject

(76) Inventor: Johnney Ray, Washingtonville, NY (US)

Correspondence Address: Sandra M. Kotin, One Fairchild Place, P.O. Box 550, Monticello, NY, 12701, US

(21) Appl. No.: 09/757,234

(22) Filed: Jan. 9, 2001

(51) Int. Cl. A61H 7/00

(52) U.S. Cl. 601/95

(57) ABSTRACT

A device and method of use to assist a subject to relax and for the relief of stress. The device is placed next to a bed where the subject lies prone. It may be situated on the floor or on a bed-side table. A sweep arm is equipped with “fingers” that make constant contact with the subject's back. The sweep arm moves in a back and forth motion controlled by a motor that is rotatably mounted at the top of a height adjustable vertical column. The motor is also equipped with an oscillator that enables the sweep arm to oscillate and another oscillator that moves the sweep arm to a rest position that is parallel to the bed and away from the subject when the device is turned off. The subject can select the desired mode of motion of the sweep arm, i.e., rotation, oscillation, or both at the same time. A timer enables the device to be turned off automatically so as not to disturb the relaxation of the subject.

### FIELD OF THE INVENTION

The instant invention relates to a device which provides continuous gentle moving contact with the human body for the purpose of relieving stress and enhancing relaxation.

### BACKGROUND OF THE INVENTION

There are a variety of devices used to message the human body and which provide many different modes of body contact. These devices exhibit a wide range in the amount of force or pressure that is exerted on the body so that a user may experience sensations ranging from a true message to a light caress. Most of the devices provide intermittant contact and most exhibit one mode of contact.

Ferguson, in U.S. Pat. No. 3,672,357, teaches a massage apparatus consisting of a rectangular frame positioned over a bed and supporting a carrier that moves in a prescribed repetitive path along a track. The carrier holds a massage applicator which makes contact with the body of a person lying prone on the bed. In one embodiment a motor drives a threaded rod in contact with the carrier causing the carrier to move back and forth over the body. The massage applicator is in the form of a large comb or dangling straps which may have different degrees of stiffness. The applicator sweeps across the entire length of the body and since the body has many contours there is intermittant contact and varying presssure. Several embodiments are described, all of which require another person to turn the device on and off since the subject is lying under the frame. The subject would have to crawl under the frame or have someone lift the frame so he can lie down within the massaging area and lift it again when he chooses to rise.

U.S. Pat. No. 4,228,794 to Boller discloses a hand held massager requiring that one person, the user, hold the device and give the massage to another person, the subject. The device has a series of protruding fingers that alternately make contact with the back of the subject This device is air cooled so the user can hold it for prolonged periods. The user can vary the pressure or degree of massage as desired. Only a small part of the body of the subject is contacted at any time and this device is not designed to provide a light or soothing touch.

A scratching and petting device for household pets is taught by Della Vecchia in U.S. Pat. No. 4,872,422. A wall mounted vertical base has a foldable horizontally extending petting arm that can be adjusted to different heights. An electric eye starts the action of the petting arm when activated by the presence of the animal. The petting arm then moves up and down. The animal learns to position itself so that the end of the arm contacts its head or back depending on the height at which the arm is set. This device has only a finger sized contact with the animal's body and would not be very soothing if used by a human. A human would have to move around to have a device such as this scratch different parts of his body and this would not be very relaxing.

Persaud teaches another type of back massager in U.S. Pat. No. 4,984,568. This device is clamped to the side rail of a bed and is for massaging an individual's back. A vertical rod is equipped with a hydraulic assembly so it can be raised or lowered. A horizontal arm, also with a hydraulic assembly, can move a massage head vertically and angularly about the back of the subject. The massage head can be fitted with rollers or resilient fingers. A control box is used to program the path of the massage head and also has a timer to set the duration of use. The head can also be used to dispense lotion. The subject can cause the head to move and to dispense lotion by means of a joy stick. This device is specifically for massages and is not designed for a light touch. By constantly moving the massage head with the joy stick, much of the pleasure of just relaxing is lost.

An automatic body massaging device is taught by Tarlow et al. in U.S. Pat. No. 5,016,617. The base of the device fits between the mattress and box spring of a conventional bed but could be used directly on the floor. A vertical column attached to the base supports a substantially oval track. A roller moves around the track and carries a leather piece cut into strips. The strips have hook and loop type fasteners at their ends to which various weights may be attached. The weighted strips provide the massage. A battery powered motor moves the roller around the track. As the roller moves around the track the strips alternately make contact and lose contact with the back of the subject. Unless the device is disconnected from the bed the track is always positioned directly over it causing the subject to duck under the track to lie down and to be careful not to hit the track when rising. Depending upon the position of the roller when the device is turned off, the strips may remain directly over the bed and in contact with the subject's back. The subject must turn the device on before lying down and rise to turn it off or have another person present for assistance.

A back massaging apparatus that rests on a bed or massage table is disclosed by Chapman in U.S. Pat. No. 5,582,582. A rectangular frame is supported on the table by means of four telescoping legs. A cross rail moves back and forth along the side rails of the frame by means of a motor which drives a chain loop positioned over each side rail. The cross rail carries a massaging unit containing four rotatable heads each having downwardly extending fingers which may be rigid or soft. A second motor turns the heads and moves the unit back and forth over the cross rail. This massager must be positioned over the subject once he is lying on the table, so there is a need for another person for assistance. The unit appears to require a fairly rigid flat surface and a bed may not offer sufficient support thus making a special massage table a necessity. The spring activated up and down motion of the massage fingers provide a substantially forceful massage, and will not give the light touch required for relaxation or sleep induction. The device would have to be lifted away from the table before the subject is able to rise.

In U.S. Pat. No. 6,074,353 Helmer discloses a device designed to caress the body. The base of the device rests on the floor. A vertical axle to which is affixed a horizontal support is caused to revolve by means of a belt driven plate. The belt is driven clockwise or counterclockwise by a motor. Strips of a soft material attached to the horizontal support move in a circular path as the vertical axle revolves. The height of the horizontal support can be adjusted along the vertical axle so the strips of soft material make contact with the subject's back. A control box enables the subject to change the speed of rotation and to stop and start the motor. As the horizontal support moves in its circular path the strips of material alternately are in contact with and are out of contact with the back of the subject. The subject has to control the device and must turn it off when finished.

Most of the prior art devices require the assistance of another person in using the device because they must be placed near or over the subject while the subject lies prone and the devices must be turned on and off manually. If the subject has to activate and deactivate the device himself it is impossible for the subject to relax completely or to fall asleep while the device is in use. The automatic massagers and caressers have strips of material that are moved across or over the back of the subject in one mode of motion. Many of the prior art devices have massage arms or elements that move in such a manner that they alternately move off and on to the back of the subject interrupting any soothing sensation the device may provide. None of the prior art devices have an automatically set rest position so that when the treatment is completed the strips remain in contact with the body and the device is suspended over the body, unless the subject leaves the bed or another person removes the device. The prior art devices that are attached to or rest on the bed during use must be removed to some other location in order to use the bed for sleeping.

There is a need for an automatic relaxation inducing device that can be utilized by the subject alone. There is a need for an automatic relaxation device that maintains constant contact with the body of the subject and that exhibits more than one mode of motion. There is a need for an automatic relaxation device that automatically removes the contact material from the body of the subject and maintains it in an out-of-the-way position when the device shuts off. There is a need for a device that enables the subject to fall asleep during use by automatically shutting off after a preset time period and that has a rest position away from the subject and the bed so the subject can comfortably move during sleep and can rise at a later time and not have the contact portion of the device hanging over and in contact with his or her body.

### BRIEF SUMMARY OF THE INVENTION

It is an object of the present invention to provide a device that will assist the subject to relax and will relieve stress.

It is an object of the present invention to provide a device that can mimic the feeling of having one's back gently stroked by a companion.

Another object of the present invention is to provide constant contact with the subject's back during the period of use.

A further object of the present invention is to have a device that can provide two modes of motion to best simulate human contact.

A still further object of the present invention is to have a device which enables the user to select the mode or modes of motion desired.

Another object of the present invention is to have a device that has a timer so the user can relax and fall asleep and the device will automatically shut off after a preset time period.

A further object of the present invention is to have a device wherein the contact portion automatically is removed from contact with the back of the user to a rest position when the device is deactivated.

The instant invention is a device to assist in the relaxation and relief of stress of a subject as the subject lies prone on a bed. The device is comprised of a horizontal sweep arm having a proximal end and a distal end; at least one contact member depending from the distal end of said horizontal sweep arm and making contact with the back of the subject; means for rotating said sweep arm across the back of the subject in a prescribed path such that the contact member remains in constant contact with the subject's back during operation and means for causing said horizontal sweep arm to oscillate. There is a vertical support column for rotatably supporting said suspension and rotation means; a base, integral with said support column, for maintaining said device on a horizontal surface; and means to move the sweep arm to a rest position when not in operation, said rest position being such that the contact member is no longer in contact with the subject and is not suspended over the bed.

A device to assist in the relaxation and relief of stress of a subject as the subject lies prone on a bed, said device comprising: a horizontal sweep arm having a proximal end and a distal end, said horizontal sweep arm being suspended over the bed during acativation of the device; at least one contact member depending from the distal end of said horizontal sweep arm for making contact with the back of the subject; means for suspending said horizontal sweep arm at its proximal end and rotating said horizontal sweep arm across the back of the subject in a prescribed path such that the contact member remains in constant contact with the subject's back during activation; means for causing said horizontal sweep arm to oscillate; a vertical support column for rotatably supporting said suspension and rotation means; and a base, integral with said vertical support column for maintaining said device on a horizontal surface.

A method for the relaxation and relief of stress of a subject when the subject lies prone on a bed, said method comprising the steps of: providing a device comprising a horizontal sweep arm having a proximal end and a distal end, said horizontal sweep arm being suspended over the bed during activation of the device; at least one contact member depending from the distal end of said horizontal sweep arm for making contact with the back of the subject; means for suspending said horizontal sweep arm at its proximal end and rotating said horizontal sweep arm across the back of the subject in a prescribed path such that the contact member remains in constant contact with the subject's back during activation; means for causing said horizontal sweep arm to oscillate; a height adjustable vertical support column for rotatably supporting said suspension and rotation means; a base, integral with said vertical support column for maintaining said device on a horizontal surface; means to move the horizontal sweep arm to a rest position when the device is deactivated, said rest position being such that the contact member is no longer in contact with the subject and the horizontal sweep arm is not suspended over the bed; means for activating the suspension and rotation means; means for activating the oscillation means; and timer means for permitting the subject to activate the device for a specific period of time after which the device will automatically be deactivated; placing the device next to the bed; adjusting the height of the vertical support support column so that the contact member will be suspended over the bed and in contact with the back of the subject when the subject lies prone on the bed and the device is activated; selecting the desired mode of activation from the choices consisting of rotation, oscillation and simultaneous rotation and oscillation; presetting the timer for a specific period of time; activating the device; and having the subject lie prone on the bed such that his or her back is continually contacted by the contact member in the mode selected; whereby the subject becomes relaxed and may eventually fall asleep and at the conclusion of the preset time period the device is deactivated and the horizontal sweep arm moves to the rest position out of the way of the subject.

Other features and advantages of the invention will be seen from the following description and drawings wherein similar reference characters are used to designate corresponding parts in all of the views.

### BRIEF DESCRIPTION OF THE DRAWING

FIG. 1 is a perspective view of the device of the instant invention in use with a subject;

FIG. 2 is close-up perspective view of the contact unit and slotted sweep arm;

FIG. 3 is a perspective view of the sweep arm and contact unit showing the sweeping mode of motion;

FIG. 4 is a perspective view of the contact unit showing the oscillating mode of motion;

FIG. 5 is a top plan view of the device showing the rest orientation of the arm;

FIG. 6 is a perspective view of an alternative contact unit;

FIG. 7 is a perspective view of a second embodiment of the device of the instant invention; and

FIG. 8 is a perspective view of an alternative sweep arm.

### DETAILED DESCRIPTION OF THE INVENTION

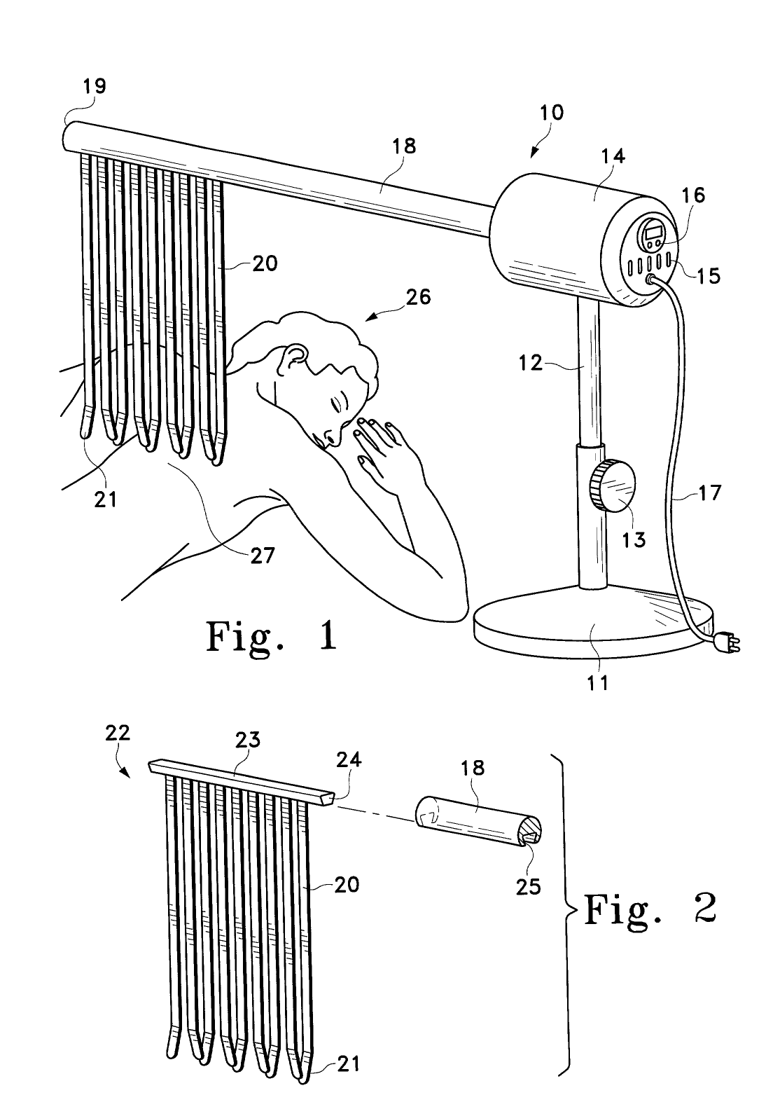

The device 10 of the instant invention is shown in FIG. 1. It may be placed on any stable horizontal planar surface such as a bed-side table or floor so that the subject may utilize the device 10 while lying prone on a bed or massage table (not shown). The device 10 may be supported by a base 11 and a height-adjustable vertical support column 12. Such height adjustable supports are well known in the art. One type of height adjustable support may have an adjustment knob 13 so that the exact height desired may be easily attained. A motor (not shown) may be rotatably mounted at the top of the support column 12. The motor may be contained within a similarly rotatably mounted housing 14. There may be ventillation openings 15 in the housing 14 to assist in the venting of any heat that may be generated by the motor. The motor may be equipped with one or more oscillators (not shown) to enable the device to provide different modes of motion and thereby different modes of contact. There may be a timer (not shown) associated with the motor so that the device 10 may be activated for specific periods of time and may thereafter shut off automatically. Such oscillators and timers are well known in the art. There may be one or more control switches 16 mounted on the exterior of the housing 14 to activate the device 10 , set the timer, and select the desired mode or modes of operation. An electric cord 17 may depend from the housing 14 when an electric motor is used, but a battery powered motor may also be utilized.

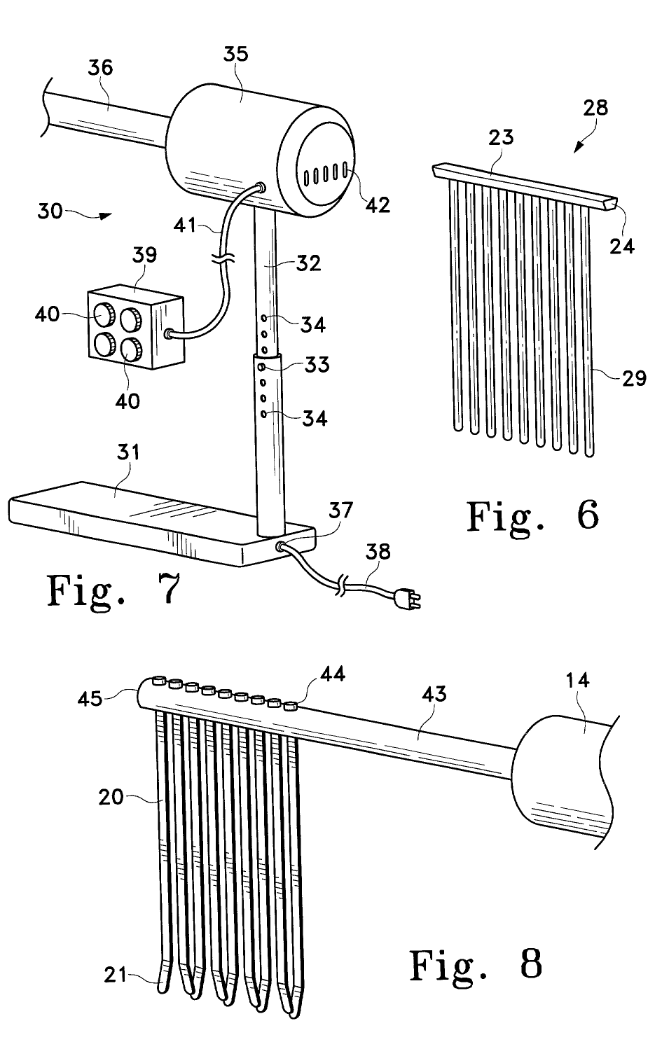

A horizontal sweep arm 18 may extend outwardly from the housing 14 and may be integral with and supported by the motor within the housing 14. The sweep arm 18 may extend a considerable distance outward from the housing 14 and may have depending from its distal end 19 a series of contact members 20. The contact members 20 may be of sufficient length to extend from the sweep arm 18 to make full contact with the back 27 of the subject 26 as he or she lies prone on the bed. The contact members 20 may be semi-rigid but pliable so as to feel like another person is moving his or her fingers and/or fingernails back and forth over the subject's back 27. There are many polymeric substances, such as a variety of plastics known in the art, that may be used for this purpose. lighter and more flexible materials may also be used, but such materials may provide a different sensation. The contact members 20 may be affixed to the sweep arm 18 in more than one manner. One such manner may be to utilize a contact unit 22 as seen in FIG. 2. The contact members 20 may be permanently affixed to a rod 23 which is shaped for reversible retention within a similarly shaped slot 25 in the sweep arm 18. The rod 23, in cross section, may be in the shape of an inverted trapezoid 24. The slot 25 may also be in the shape of an inverted trapezoid. The rod 23 may slide into the slot 25 and be held there securely, but may also be easily removed therefrom. This structure may enable one contact unit 22 to be exchanged for another contact unit 28 having different contact members 29, FIG. 6, which may alter the sensation felt during use.

The contact members 20 may also be permanently affixed to a different form of sweep arm 43, FIG. 8, by having them threaded through openings (not shown) in the distal end 45 of the sweep arm 43 and then held in place by fasteners 44. When this form of sweep arm 43 is used, different contact members 29 may be individually threaded and fastened along the distal end 45 of the sweep arm 43, or, the entire sweep arm 43 with contact members 20 attached may be changed at its point of attachment (not shown) to the motor within the housing 14.

The contact members 20 may have bends at their ends 21, like fingernails FIGS. 1 and 2, which may better simulate the feeling of fingernails stroking the back, or the contact members 29 may be straight, FIG. 6,which may provide a slightly different sensation during use.

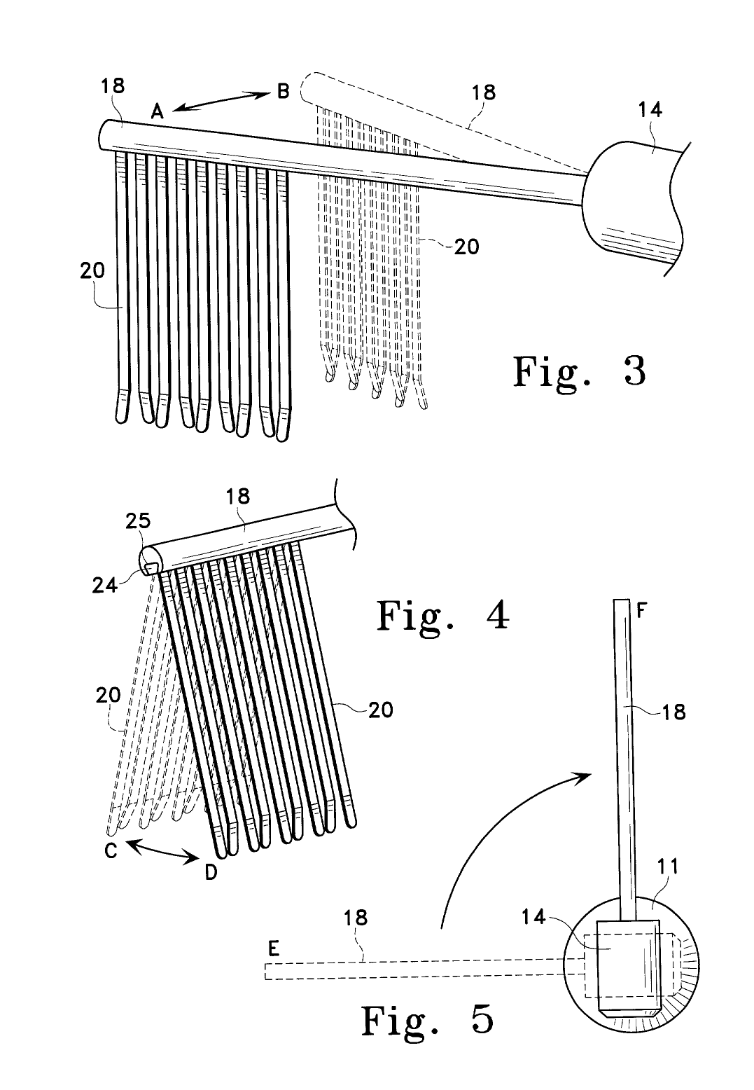

When the device 10 is turned on the sweep arm 18 may be caused to sweep back and forth, by means of an appropriate oscillator, through an arc A-B, FIG. 3. Arc A-B may be from 30° to 50° to insure that the contact members 20 may be in constant contact with the back 27 of the subject 26. While the sweep arm 18 is moving back and forth the contact members 20 may simultaneously be made to oscillate, by means of another oscillator, through an arc C-D, FIG. 4, or the oscillating motion may be used singularly, thus the contact members 20 are capable of two modes of motion. The subject 26 may elect to utilize only the sweeping mode FIG. 3, only the oscillating mode FIG. 4, or both the sweeping mode and the oscillating mode at the same time. Each selection may provide different sensations on the back 27 of the subject 26, and in all selections, the contact members 20 or 29 may be in constant contact with the subject's back 27 during the period of operation of the device 10.

The device 10 may relieve stress and assist the subject 26 to relax. The constant contact and gentle stroking may also cause the subject 26 to fall asleep while the device 10 is still in use. Since the subject 26 must be positioned so that the sweep arm 18 is directly over and in contact with his or her back 27, the presence of the sweep arm 18 may present a problem when the subject 26 wakens and wishes to rise from the bed or even when the subject 26 moves or turns over during sleep. The device 10 may be fitted with a separate oscillator (not shown) which may cause the sweep arm 18 to swing out of the way to a rest position, an orientation that is 90° from its position directly over the subject 26, when the device 10 is turned off, or shuts off automatically. FIG. 5 shows the sweep arm 18 in a use position E in dotted lines and in the rest position F.

A second embodiment of the device 30 is seen in FIG. 7. A housing 35 is rotatably supported atop a height-adjustable vertical support column 32 which communicates with a somewhat different base 31. The vertical suppport column 32 and the base 31 form an L-shape that may enable the base 31 to be positioned entirely under a bed (not shown). The vertical support column 32 may be adjusted by means of spring activated buttons 33 that may extend through openings 34 in the support column 32. An electric cord 38 may extend through an opening 37 at the bottom of the support column 32. Methods are well known in the art to have an electric cord pass through an adjustable column. There may be a second cord 41 extending from the housing 35 to a control box 39. The cord 37 may be long enough so that the control box 39 may be disposed on the bed where the subject may turn on the device 30, set the timer, and select the desired mode or modes of motion. He or she may also change any of the settings without having to change position. The control box 39 may contain all necessary dials or buttons 40. In the alternative, the selections may be made using a similar control box that may utilize remote control means (not shown) which may negate the need for the second cord 41. There may be ventillation openings 42 in the housing 35 to assist in venting any heat that may be generated by the motor (not shown) within the housing 35.

To utilize the device 30 the subject may position the device 30 next to the bed, make any necessary height adjustments, take his or her place on the bed and, with the control box 39 at hand, set the timer and desired mode or modes of motion of the sweep arm 36 and just relax. When the selected time period is concluded the device 30 may automatically turn off and the sweep arm 36 move to the rest position FIG. 5. Thus when the subject awakes there may be no object suspended over him or her. If the subject does not fall asleep he or she may change the settings at any time. If the controls are affixed to the housing 14 as illustrated in FIG. 1, the timer may be set and selections made before the subject lies down on the bed. All of the settings may still be made by the subject 26 without the need for the assistance of a second person.

While two embodiments of the present invention have been illustrated and described in detail, it is to be understood that this invention is not limited thereto and may be otherwise practiced within the scope of the following claims.

What is claimed is:

1. A device to assist in the relaxation and relief of stress of a subject as the subject lies prone on a bed, said device comprising:
a horizontal sweep arm having a proximal end and a distal end, said horizontal sweep arm being suspended over the bed during acativation of the device;
at least one contact member depending from the distal end of said horizontal sweep arm for making contact with the back of the subject;
means for suspending said horizontal sweep arm at its proximal end and rotating said horizontal sweep arm across the back of the subject in a prescribed path such that the contact member remains in constant contact with the subject's back during activation;
means for causing said horizontal sweep arm to oscillate;
a vertical support column for rotatably supporting said suspension and rotation means;
a base, integral with said vertical support column for maintaining said device on a horizontal surface; and
means to move the horizontal sweep arm to a rest position when the device is deactivated, said rest position being such that the contact member is no longer in contact with the subject and the horizontal sweep arm is not suspended over the bed.

2. A device as in claim 1 further comprising means for activating the suspension and rotation means.

3. A device as in claim 2 further comprising timer means to enable the subject to preset the duration of activation of the suspension and rotation means.

4. A device as in claim 1 further comprising means for activating the oscillation means.

5. A device as in claim 4 further comprising timer means to enable the subject to preset the duration of activation of the oscillation means.

6. A device as in claim 1 further comprising a control unit for use by the subject to control the rotation and oscillation of the device.

7. A control unit as in claim 6 further comprising timer means to enable the subject to preset the duration of rotation and oscillation of the device.

8. A device as in claim 1 wherein the horizontal sweep arm further comprises means to reversibly retain said contact member such that one contact member can be exchanged for another contact member.

9. A device as in claim 1 wherein the contact member comprises a plurality of elongated semirigid pliable elements.

10. A device as in claim 9 wherein the semirigid pliable elements have a bend at one end.

11. A device as in claim 1 wherein the prescribed path of rotation of the horizontal sweep arm is an arc.

12. A device as in claim 11 wherein the arc is from 30° to 50°.

13. A device as in claim 1 further comprising housing means, rotatably mounted at the top of the vertical support column, for containment of said suspension and rotation means.

14. A device as in claim 13 further comprising control means affixed to said housing means, said control means for activating said suspension and rotation means and said oscillation means.

15. A device as in claim 14 further comprising timer means thereby enabling the subject to preset the duration of activation.

16. A device as in claim 1 wherein the vertical support column is height adjustable.

17. A device as in claim 1 wherein said contact member further comprises a contact unit having a plurality of contact elements depending therefrom.

18. A device as in claim 17 wherein said horizontal sweep arm further comprises means to reversibly seat said contact unit whereby one contact unit may easily be exchanged for another contact unit having different contact elements.

19. A device to assist in the relaxation and relief of stress of a subject as the subject lies prone on a bed, said device comprising:
a horizontal sweep arm having a proximal end and a distal end, said horizontal sweep arm being suspended over the bed during acativation of the device;
at least one contact member depending from the distal end of said horizontal sweep arm for making contact with the back of the subject;
means for suspending said horizontal sweep arm at its proximal end and rotating said horizontal sweep arm across the back of the subject in a prescribed path such that the contact member remains in constant contact with the subject's back during activation;
means for causing said horizontal sweep arm to oscillate;
a vertical support column for rotatably supporting said suspension and rotation means; and
a base, integral with said vertical support column for maintaining said device on a horizontal surface.

20. A method for the relaxation and relief of stress of a subject when the subject lies prone on a bed, said method comprising the steps of:
providing a device comprising a horizontal sweep arm having a proximal end and a distal end, said horizontal sweep arm being suspended over the bed during activation of the device; at least one contact member depending from the distal end of said horizontal sweep arm for making contact with the back of the subject; means for suspending said horizontal sweep arm at its proximal end and rotating said horizontal sweep arm across the back of the subject in a prescribed path such that the contact member remains in constant contact with the subject's back during activation; means for causing said horizontal sweep arm to oscillate; a height adjustable vertical support column for rotatably supporting said suspension and rotation means; a base, integral with said vertical support column for maintaining said device on a horizontal surface; means to move the horizontal sweep arm to a rest position when the device is deactivated, said rest position being such that the contact member is no longer in contact with the subject and the horizontal sweep arm is not suspended over the bed; means for activating the suspension and rotation means; means for activating the oscillation means; and timer means for permitting the subject to activate the device for a specific period of time after which the device will automatically be deactivated;
placing the device next to the bed;
adjusting the height of the vertical support support column so that the contact member will be suspended over the bed and in contact with the back of the subject when the subject lies prone on the bed and the device is activated;
selecting the desired mode of activation from the choices consisting of rotation, oscillation and simultaneous rotation and oscillation;
presetting the timer for a specific period of time;
activating the device; and
having the subject lie prone on the bed such that his or her back is continually contacted by the contact member in the mode selected;
whereby the subject becomes relaxed and may eventually fall asleep and at the conclusion of the preset time period the device is deactivated and the horizontal sweep arm moves to the rest position out of the way of the subject.
